(19) United States
(12) Patent Application Publication
(10) Pub. No.: US 2005/0206940 A1
(43) Pub. Date: Sep. 22, 2005

(54) Printer driving method for fast release of control privilege

(76) Inventor: Albert Lin, Taipei City (TW)

Correspondence Address: RABIN & BERDO, P.C., Suite 500, 1101 14 Street, N.W., Washington, DC, 20005, US

(21) Appl. No.: 11/050,859

(22) Filed: Feb. 7, 2005

(30) Foreign Application Priority Data
Mar. 19, 2004 (TW) 93107570

(51) Int. Cl. G06F 15/00

(52) U.S. Cl. 358/1.13; 358/1.1

(57) ABSTRACT

A printer driving method for fast release of control privilege provides a printer processor processing a render module and a filter module in the background. After processing the print command by an application program, a printer driver converts the print command of an output object into a particular meta file using a kind of printer language. Meanwhile, the meta file is submitted to the printer processor in the background and the control privilege is released to the application program at the same time. Thereby, the operation system has enhanced efficiency since the application program will not be suspended during the printing process.

### BACKGROUND OF THE INVENTION

1. Field of the Invention

The present invention provides a printer driving method for a fast release of control privilege when processing a print job, and especially used in the Windows 9X/2K/XP/NT operating systems or the like.

2. Description of Related Art

With the advancement of information technology, the computer is essential to the personal use. Moreover, a printer is also part of the application of the computer, and even is one of the most important peripheral products. There are many kinds of printers which includes dot matrix, ink-jet, and laser printers.

Like some peripherals, the processing speed of a printer is much slower than a computer. Conventionally, when the computer is processing a print job, the operation system (OS) within submits the control privilege of the printer to the printer driver. To ensure the efficiency of the operation system and raise the printing speed, the most printers using page description language (PDL) are equipped with the random-access memory (RAM). Thereby, the driver needs to output and save the print data in the memory of the printer and submit the control privilege to the operation system. For this reason, a higher-level printer is also equipped with a bigger memory.

Nevertheless, if the memory is not enough, as printing a large amount of data, the printer driver and the operation system must still wait for the printing process until the operation system retrieves the control privilege when the print job is finished. In this printing process, the operation system does not have the control privilege because the privilege belongs to the printer driver, and thus the OS cannot process any other programs in the computer. In addition, a high-level printer is very expensive since the memory is expensive.

There is a kind of cheaper printer with a graphics device interface (GDI), whose printing processes are mostly executed in the personal computer, so the application program needs to wait for a long processing time when lots of data are printed. In conclusion, the computer is not efficient during printing since it cannot retrieve the control privilege until the printing processes are finished.

For improving the demerit of the conventional GDI printer in the printing process, the present invention provides a printer driving method for fast release of control privilege. To raise the efficiency of the OS, a printing processor processes the print job in the background as long as a printer driver is producing a print command and converting the command into a particular meta file; the application program can then retrieve the control privilege.

### SUMMARY OF THE INVENTION

Broadly speaking, the present invention provides a printer driving method for fast release of control privilege, which is submitted to an application program after a print job is submitted by an operation system. Therefore, for substantially promoting the efficiency of the OS, and especially in the Windows system, the application program does not need to wait for a long processing time while the print data is being processed because the printer processor processes the print job in the background.

For the main purpose recited above, the method for fast release of control privilege is used in the Windows system. When an application program outputs a print command, the control privilege of the OS is submitted to a printer driver, then the print data is output to a driver module by executing a system graphics device interface (GDI) and the print job is processed in the background, thereby the control privilege of the OS is released until the process is finished.

More particularly, the method for releasing control privilege includes the step of outputting a print data to a driver module, in which the driver module comprises an image module, a text module, a graphics module and a driver input/output module. Wherein, a graphics user interface (GUI) retrieves a text, image or input/output file from a resource file, which is converted into a memory or a buffer by an output converter.

Furthermore, the method for releasing control privilege includes the step of processing the print job in the background by a printer processor. Then a path selector is used to retrieve the file converted from the GDI and the print data in the memory and the buffer, and to submit the print job to the distinct render modules as the request for a image printing, a text printing or a graphics printing. Finally, the output data is transformed into a unit of 24-bit R.G.B data.

Furthermore, the method for releasing control privilege of the present invention includes the step of processing the print job in the background by a printer processor, and further includes the processes of color matching, filtering and arranging a 24-bit data unit by a filter module, and printing out from a printer.

### BRIEF DESCRIPTION OF DRAWINGS

The present invention will be readily understood by the following detailed description in conjunction accompanying drawings, in which:

FIG. 1 is a flow chart relating to the processing steps of a printer driver of the prior art;

FIG. 2 is a structure of the printer driver of the present invention; and

FIG. 3 is a flow chart of the processing steps of the printer driver of the present invention.

### DETAILED DESCRIPTION OF THE PREFERRED EMBODIMENTS

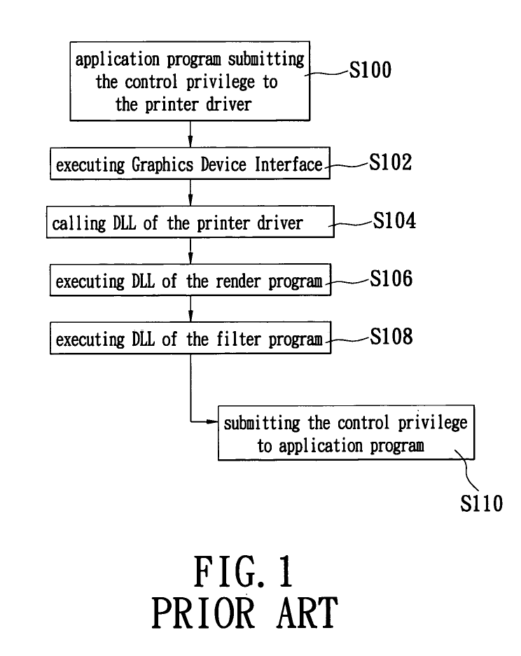

Reference is made to FIG. 1, which shows a flow chart of the processing steps for a conventional printer driver. As an application program is processing a printing process, the control privilege is submitted from the Windows system to the printer driver (step S100). Then the printer driver executes a graphics device interface (GDI) (step S102). The GDI is the standard printing language, which adopts a plurality of commands showing the image objects and transferring to the printer, thus printing what the user sees.

Next, a dynamic link library (DLL) of the printer driver is called (step S104). In general, the DLL of the printer driver should handle an image module, a text module and a graphics module, to which the printer driver submits distinct requests, respectively.

The printer driver executes the DLL of a render program by the default printer processor of the Windows system, and processes the color output as requested by the GDI (step S106). Then a DLL of a filter program is executed, and it goes through the processes of color matching, filtering and arranging the print data (step S108), and finally printing out from a printer. After that, the printer driver submits the control privilege to the Windows system (step S110).

As in the prior art recited above, the default printer processor of the operation system is executed in accordance with the output data from the printer driver, and then a render DLL and filter DLL are called for data printing. However, when a large amount of data needs to be printed, the printer driver must spend a long time in processing, the application program of the operation system will be suspended for a long time and the users will be discontented.

The main purpose of the present invention is to provide a printer driving method for fast release of control privilege in the framework of a Windows system, i.e. Windows 9X/2K/XP/NT or the like.

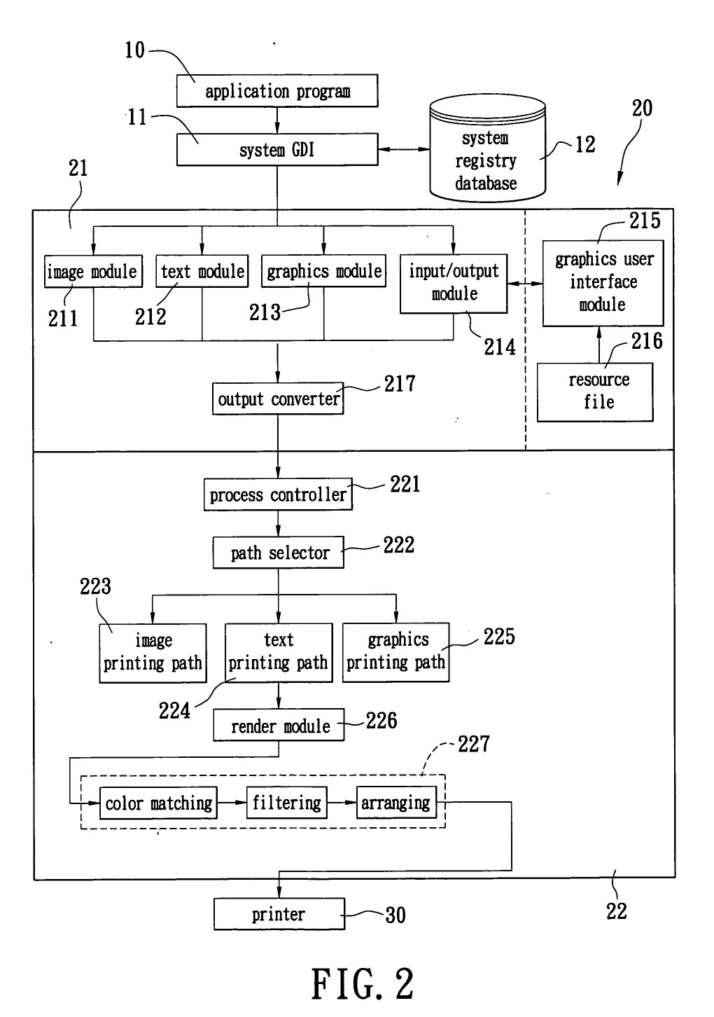

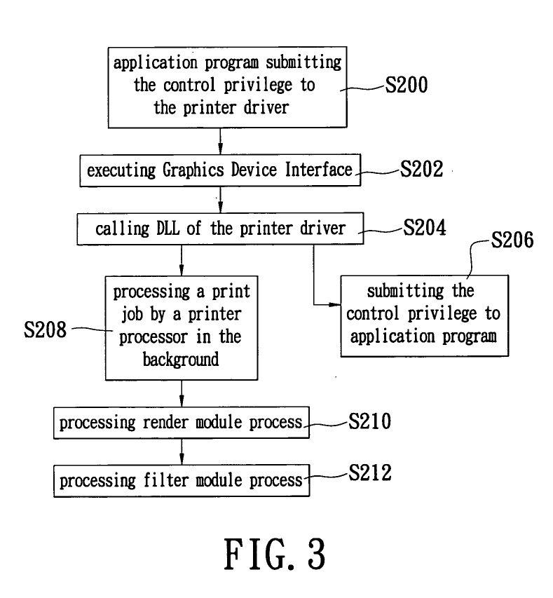

An application program of the Windows system submits the process of the printer driver to a specific printer processor processing a render module and a filter module in the background. Then the control privilege is submitted back to the application program of the operation system. Reference is made to FIG. 2, which shows a structure of the printer driver of the present invention, and further to FIG. 3, which shows a flow chart of the processing steps of the printer driver.

An application program 10 of an operation system outputs a print command; i.e. the application program submits the control privilege to a printer driver of the operation system (step S200). Then a graphics device interface (GDI) 11 is executed (step S202). Meanwhile, the graphics device interface 11 corresponded to a specific printer is retrieved from a system registry database 12 and is output to the printer driver 20 of the present invention (step S204). Wherein the printer driver 20 comprises a driver module 21 and a raster image processing module (RIP) 22.

The driver module 21 mentioned above further comprises an image module 211, a text module 212, and a graphics module 213. The driver module 21 also executes the related modules according to the distinct request of each GDI. The driver module 21 includes a driver input/output module 214 retrieving the text, image or input/output file from a resource file 216, and the GDI and print data are converted by a output converter 217 to a memory or a buffer.

After the step of processing driver module 21, the control privilege is submitted to application program 10 of the operation system (step S206). Additionally, the print job is processed by a printer processor in the background (step S208), and the printer processor is used to process the raster image processing module 22.

A process controller 221 is included in the raster image processing module 22. The process controller 221 schedules the background printing process of the printer processor. In the process of printing, the GDI and the converted print data in memory or in buffer is retrieved by a path selector 222, and output to the corresponding paths including an image printing path 223, a text printing path 224 and a graphics printing path 225 as the request for image printing, text printing or graphics printing. Then the output data in each path is converted into a 24-bit R.G.B. data unit by a render module 226 (step S210).

Next, the 24-bit R.G.B. data unit is processed by a filter module 227, and is further color matched, filtered and arranged (step S212), and finally printed out from a printer 30.

Significantly, the printer driver mentioned in the present invention is used to process the render module and the filter module in the background by a specific printer processor. After the print command is processed by the application program, the printer driver converts the print command and submits it to the printer processor in the background; meanwhile the control privilege is released to the application program. Therefore, the application program does not need to wait for a long processing time when lots of data are printed.

The many features and advantages of the present invention are apparent from the written description above and it is intended by the appended claims to cover all. Further, since numerous modifications and changes will readily occur to those skilled in the art, it is not desired to limit the invention to the exact construction and operation as illustrated and described. Hence, all suitable modifications and equivalents may be resorted to as falling within the scope of the invention.

1. A printer driving method for fast release of control privilege, the method being used under a Windows operation system when a print command is output from an application program, the method comprising the steps of:
submitting the control privilege from the application program to a printer driver;
executing a graphics device interface (GDI), and outputting a print data to a driver module;
releasing the control privilege to the operation system; and
processing a print job by a printer processor in the background.

2. The printer driving method for fast release of control privilege as recited in claim 1, wherein the operation system is Windows 9X, Windows 2K, Windows XP Windows NT or the like.

3. The printer driving method for fast release of control privilege as recited in claim 1, wherein the step of executing the graphics device interface (GDI) is to retrieve the GDI for the printer from a system registry database.

4. The printer driving method for fast release of control privilege as recited in claim 1, wherein in the step of outputting the print data to the driver module, the driver module includes an image module, a text module, a graphics module, and an input/output module, a graphics user interface (GUI) retrieves the text, image or input/output file of a resource file, and an output converter converts the GDI and the print data into a memory or a buffer.

5. The printer driving method for fast release of control privilege as recited in claim 1, wherein the step of processing the print job by the printer processor in the background is executed by scheduling the background printing process of the printer processor by a process controller.

6. The printer driving method for fast release of control privilege as recited in claim 1, wherein the step of processing the print job by the printer processor in the background, a path selector is used to retrieve a file converted from the GDI and the print data in a memory or a buffer, and submits the file to a corresponding paths as the request for a image printing, a text printing or a graphics printing, then a render module transforms the file in each corresponding path into a 24-bit R.G.B. data unit.

7. The printer driving method for fast release of control privilege as recited in claim 6, wherein the step of processing the print job by the printer processor in the background further includes processes of color matching, filtering and arranging the 24-bit R.G.B. data unit with a filter module, and then printing out from a printer.
